(19) United States
(12) Patent Application Publication
(10) Pub. No.: US 2025/0181669 A1
(43) Pub. Date: Jun. 5, 2025

(54) CONTROL METHOD OF A CONSECUTIVE CONVOLUTION STRUCTURE

(71) Applicant: NOVATEK MICROELECTRONICS CORP., HSINCHU (TW)

(72) Inventors: LI-QUN WENG, MIAOLI COUNTY (TW); CHIEH-CHENG CHEN, CHANGHUA COUNTY (TW)

(21) Appl. No.: 18/524,255

(22) Filed: Nov. 30, 2023

(51) Int. Cl. G06F 17/15

(52) U.S. Cl. CPC G06F 17/15

(57) ABSTRACT

A control method of a consecutive convolution structure is provided. A first line, a second line of an input data and a first and second padding line can be adopted for applying Winograd convolution and generating a first line of an output data in an odd output layer. In addition, a first, a second and third line of an input data and a third padding line can be adopted for applying the Winograd convolution and generating a first line and a second line of an output data in an even output layer. The disclosed control method is proposed as integrating the Winograd convolution with a line interleaved process, so as to effectively reduce the array area of multiply accumulate circuits and power consumption thereof. In addition, a minimum latency of the convolutional neural network model can be achieved by employing the disclosed control method of the present invention.

### BACKGROUND OF THE INVENTION

### Field of the Invention

The present invention is related to an improved depth-first Winograd convolutional algorithm technology. More particularly, the present invention is aimed to provide a control method of a consecutive 3*3-kernel convolution structure, in which the disclosed control method is characterized by integrating the Winograd convolution with a line interleaved process so as to effectively reduce the array area of multiply accumulate circuits and power consumption thereof.

### Description of the Prior Art

As known, in recent years, since the modern artificial intelligence (AI) technologies have developed significantly and rapidly, a Convolutional Neural Network (CNN) has been widely used in the related AI industries. In general, the convolutional neural networks (CNNs) have demonstrated superior quality for computational imaging applications such as super-resolution, denoising and deblurring. Although it has been acknowledged that the CNNs have the advantages of high quality in computational imaging, it is also noticeable that relatively high complexity of its neural network architecture remains unsolved in recent years due to the increasing amount of image resolution and process time of computation of the convolutional neural networks. As such, in order to achieve the real-time computation and reduce the model latency of the computing algorithm for a convolutional neural network, related research on computation acceleration of the convolutional neural network algorithm in AI related fields have been pursued in the existing technologies so far.

Regarding the general AI algorithm technologies, it has been known that the convolutional neural networks always require large amounts of computing resources for both training and inferences, primarily because the convolution layers in the convolutional neural network structures are computationally intensive. Fast convolution algorithms such as Winograd convolution is by far, believed to be used so as to greatly reduce the computational cost of these layers. On the other hand, it is also known that on-chip memory resource and off-chip memory bandwidth are also the key indices and will deteriorate considerably due to the increasing of resolution and frame rate of the display for the consumer electronics. Certain recent works have proposed an advanced layer-fusion method relying on the line-based depth-first processing, which can significantly reduce the on-chip memory resource and further shorten the network latency of the convolutional neural network in a low-bandwidth (or zero-bandwidth) manner. However, in such a type of line-based depth-first processing flow, each line of the intermediate feature of each convolution layer in the convolutional neural network will process independently in a depth-first schedule, which is incompatible with the pairwise multiplication characteristic of Winograd convolution. Although the line-based processing flow can be scheduled in a non-depth-first manner to fit the input and output block size of Winograd convolution, it also cancels out the advantage of low network latency and low on-chip memory requirement. On account of all, it is noticeable that how to combine both the advantages of Winograd convolution and line-based depth-first processing flow is still an open issue to be solved. As a result, it, in view of all, should be apparent and obvious that there is indeed an urgent need for the professionals in the field for a novel and inventive convolution algorithm to be developed, so as to solve the above-mentioned issues existing in the current technologies.

### SUMMARY OF THE INVENTION

In order to overcome the above-mentioned issue, one major objective in accordance with the present invention is to provide an improved Winograd convolutional algorithm. According to the present invention, the disclosed improved convolutional algorithm is based on a depth-first processing flow and is involved with integrating the line interleaved computing methods, so as to achieve a minimum latency of the convolutional neural network model.

Another objective in accordance with the present invention is to provide a novel control method of a consecutive convolution structure with a kernel size equal to 3*3. By employing the proposed control method of the consecutive 3*3-kernel convolution structure, it is believed that residual connection data as well as activation data that needs to be temporarily stored in each layer while performing the algorithm can be reduced. By employing the technical solution disclosed in the present invention, the requirements for static random-access memories (SRAM) layouts can be effectively reduced, such that both power and area waste can be suppressed due to the improved convolutional algorithm integrating with line interleaved computing methods as disclosed in the present invention.

To be specific, please refer to one embodiment of the present invention, a control method of a consecutive convolution structure is provided. The disclosed control method of the consecutive convolution structure comprises a plurality of following steps of:
(a) in a first operation period, receiving a first line and a second line of an input data, applying Winograd convolution and generating a first line of an output data;
(b) in a second operation period, receiving a third line and a fourth line of the input data, applying Winograd convolution and generating a second line and a third line of the output data; and
(c) in a third operation period, receiving a fifth line and a sixth line of the input data, applying Winograd convolution and generating a fourth line and a fifth line of the output data.

In another aspect, the present invention is also aimed to provide a control method of a consecutive convolution structure, comprising a following plurality of steps of:
(a) in a first operation period, receiving a first line, a second line and a third line of an input data, applying Winograd convolution and generating a first line and a second line of an output data;
(b) in a second operation period, receiving a fourth line and a fifth line of the input data, applying Winograd convolution and generating a third line and a fourth of the output data; and
(c) in a third operation period, receiving a sixth line and a seventh line of the input data, applying Winograd convolution and generating a fifth line and a sixth line of the output data.

In view of the various embodiments of the present invention, it is also provided that at least one padding line can be selectively adopted so as to provide dummy data, zero-point data or duplicate image data for performing the Winograd convolution.

Or alternatively, the at least one padding line may also be adopted for providing an image data which is identical to the first line of the input data in order to perform the Winograd convolution. Various implementations are preferably feasible by people who are skilled in the arts.

As a result, it should be noted that, according to the disclosed embodiment of the present invention, the alternatives and modifications will be apparent to those skilled in the art, once informed by the present disclosure. And the present disclosure certainly claims and covers the alternatives and modifications with equality.

The present invention should not be limited thereto the disclosed embodiments as provided in the present invention. In other words, the provided technical contents of the invention may also be widely utilized in view of other and various alternatives and modifications, which will be apparent to those skilled in the art, once acknowledged by the disclosed disclosure. As a result, it is to be understood that both the foregoing general description and the following detailed description are exemplary and are intended to provide further explanation of the invention as claimed. When adopting the proposed technical contents of the present invention, these and other objectives of the present invention will become obvious to those of ordinary skill in the art after reading the following detailed description of preferred embodiments.

### BRIEF DESCRIPTION OF THE DRAWINGS

The accompanying drawings are included to provide a further understanding of the present invention, and are incorporated in and constitute a part of this specification. The drawings illustrate the embodiments of the present invention and, together with the following descriptions, which are served to explain the principles of the present invention. As following, in the drawings:

FIG. 1 shows a diagram schematically illustrating an image process consecutive convolution structure when a first row line of the input data is transmitted to the input layer for receiving.

FIG. 2 shows a diagram schematically illustrating an image process consecutive convolution structure after FIG. 1 when the second row line of the input data is transmitted to the input layer for receiving and a first padding line and a second padding line are provided.

FIG. 3 shows a diagram schematically illustrating an image process consecutive convolution structure after FIG. 2 when the third row line of the input data is transmitted to the input layer for receiving.

FIG. 4 shows a diagram schematically illustrating an image process consecutive convolution structure after FIG. 3 when the fourth row line of the input data is transmitted to the input layer for receiving and a third padding line, a fourth padding line and a fifth padding line are provided.

FIG. 5 shows a diagram schematically illustrating an image process consecutive convolution structure after FIG. 4 when the fifth row line of the input data is transmitted to the input layer for receiving.

FIG. 6 shows a diagram schematically illustrating an image process consecutive convolution structure after FIG. 5 when the sixth row line of the input data is transmitted to the input layer for receiving and a sixth padding line, a seventh padding line and an eighth padding line are provided.

FIG. 7 shows a diagram schematically illustrating an image process consecutive convolution structure after FIG. 6 when the seventh row line of the input data is transmitted to the input layer for receiving.

FIG. 8 shows a diagram schematically illustrating an image process consecutive convolution structure after FIG. 7 when the eighth row line of the input data is transmitted to the input layer for receiving.

FIG. 9 shows a diagram schematically illustrating an image process consecutive convolution structure after FIG. 8 when the ninth row line of the input data is transmitted to the input layer for receiving.

FIG. 10 shows a diagram schematically illustrating an image process consecutive convolution structure after FIG. 9 when the tenth row line of the input data is transmitted to the input layer for receiving.

FIG. 11 shows a process flow of the disclosed control method of the consecutive convolution structure for obtaining the output layer queue in the odd output layers according to one embodiment of the present invention.

FIG. 12 schematically shows a diagram of the consecutive convolution structure illustrating a first operation period of the disclosed control method according to the process flow of FIG. 11.

FIG. 13 schematically shows a diagram of the consecutive convolution structure illustrating a second operation period of the disclosed control method according to the process flow of FIG. 11.

FIG. 14 schematically shows a diagram of the consecutive convolution structure illustrating a third operation period of the disclosed control method according to the process flow of FIG. 11.

FIG. 15 shows a process flow of the disclosed control method of the consecutive convolution structure for obtaining the output layer queue in the even output layers according to another embodiment of the present invention.

FIG. 16 schematically shows a diagram of the consecutive convolution structure illustrating a first operation period of the disclosed control method according to the process flow of FIG. 15.

FIG. 17 schematically shows a diagram of the consecutive convolution structure illustrating a second operation period of the disclosed control method according to the process flow of FIG. 15.

FIG. 18 schematically shows a diagram of the consecutive convolution structure illustrating a third operation period of the disclosed control method according to the process flow of FIG. 15.

### DESCRIPTION OF THE PREFERRED EMBODIMENTS

Reference will now be made in detail to embodiments illustrated in the accompanying drawings. Wherever possible, the same reference numbers are used in the drawings and the description to refer to the same or like parts. In the drawings, the shape and thickness may be exaggerated for clarity and convenience. This description will be directed in particular to elements forming part of, or cooperating more directly with, methods and apparatus in accordance with the present disclosure. It is to be understood that elements not specifically shown or described may take various forms well known to those skilled in the art. Many alternatives and modifications will be apparent to those skilled in the art, once informed by the present disclosure.

Unless otherwise specified, some conditional sentences or words, such as “can”, “could”, “might”, or “may”, usually attempt to express that the embodiment in the invention has, but it can also be interpreted as a feature, element, or step that may not be needed. In other embodiments, these features, elements, or steps may not be required.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.” The phrases “be coupled to,” “couples to,” and “coupling to” are intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

The invention is particularly described with the following examples which are only for instance. Those skilled in the art will readily observe that numerous modifications and alterations of the device and method may be made while retaining the teachings of the invention. Accordingly, the following disclosure should be construed as limited only by the metes and bounds of the appended claims. In the whole patent application and the claims, except for clearly described content, the meaning of the article “a” and “the” includes the meaning of “one or at least one” of the element or component. Moreover, in the whole patent application and the claims, except that the plurality can be excluded obviously according to the context, the singular articles also contain the description for the plurality of elements or components. In the entire specification and claims, unless the contents clearly specify the meaning of some terms, the meaning of the article “wherein” includes the meaning of the articles “wherein” and “whereon”. The meanings of every term used in the present claims and specification refer to a usual meaning known to one skilled in the art unless the meaning is additionally annotated. Some terms used to describe the invention will be discussed to guide practitioners about the invention. Every example in the present specification cannot limit the claimed scope of the invention.

In the following descriptions, a control method of a consecutive convolution structure will be provided. The proposed control method is applicable to a consecutive convolution structure having a kernel size, which is, for instance, equal to 3×3. Alternatively, the disclosed control method regarding the consecutive convolution structure, as provided below may also be applied to other consecutive convolution structures having various kernel size. It should be noted that the present invention is certainly not limited thereto.

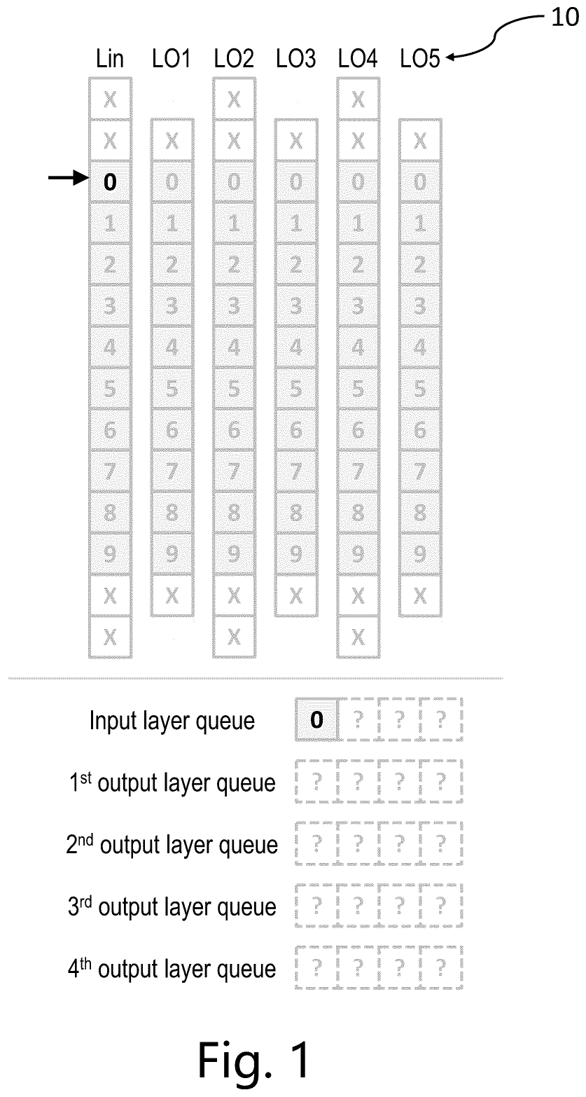

Please refer to FIG. 1 first, which shows a diagram schematically illustrating an image process consecutive convolution structure before the disclosed control method of the present invention is applied. As can be seen in FIG. 1, the consecutive convolution structure 10 includes an input layer Lin, a first output layer LO1, a second output layer LO2, a third output layer LO3, a fourth output layer LO4 and a fifth output layer LO5. A Winograd convolution is applied between each layer for image processing. For example, the Winograd convolution may comprise and yet not limited to a Winograd transformation, an element-wise multiplication, and an inverse Winograd transformation. Since the Winograd convolution algorithm has been known in the related technical fields for people who are skilled in the arts, the detailed descriptions are to be omitted hereinafter in the following paragraphs of the present invention. In general, it is known that the Winograd convolution is applied between each of the image data layers, including between the input layer Lin and the first output layer LO1, such that the image data of the input layer Lin can be transformed into the image data in the first output layer LO1 by employing the Winograd convolution. And subsequently, the Winograd convolution is again applied between the first output layer LO1 and the second output layer LO2, such that the image data of the first output layer LO1 is successively be transformed into the image data in the second output layer LO2 by employing the Winograd convolution. As a result, by applying the same manners, the Winograd convolution is then repeatedly applied between the second output layer LO2 and the third output layer LO3, and between the third output layer LO3 and the fourth output layer LO4, and between the fourth output layer LO4 and the fifth output layer LO5 for image data transformation.

As can be seen in FIG. 1, the image data of the input layer Lin is an input data which comprises a number of ten row lines “0”, “1”, “2”, “3”, “4”, “5”, “6”, “7”, “8”, “9”. And each of the row line data will be sequentially received and transmitted to the input layer Lin. In FIG. 1, the first row line “0” of the input data is firstly transmitted to the input layer Lin for receiving.

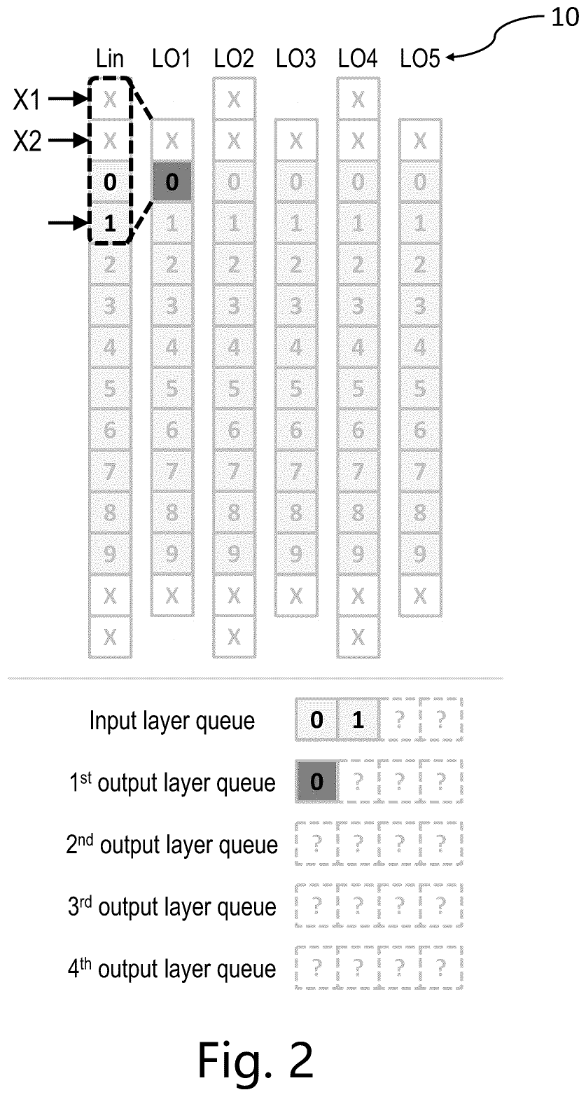

Next on, please refer to FIG. 2, which successively shows a diagram schematically illustrating an image process consecutive convolution structure after FIG. 1. As can be seen in FIG. 2, after the first row line “0” of the input data is received, the second row line “1” of the input data is sequentially transmitted to the input layer Lin for receiving. And, after the first row line “0” and the second row line “1” of the input data are both received, a first padding line X1 and a second padding line X2 are provided, for the Winograd convolution being performed between the input layer Lin and the first output layer LO1 such that the first output layer queue can be generated. According to one embodiment of the present invention, either the first padding line X1 or the second padding line X2 can be used for providing zero-point data. Alternatively, according to one another feasible embodiment of the present invention, then either the first padding line X1 or the second padding line X2 can be used for providing an image data which is identical to the first line of the input data, which is the first row line “0” of the input data. As a result, after receiving the first padding line X1, the second padding line X2, the first row line “0” and the second row line “1” of the input data, the Winograd convolution between the input layer Lin and the first output layer LO1 can be performed so as to generate the first output layer queue. As can be seen in FIG. 2, at this point of time, the generated first output layer queue is the first line “0” of the first output layer LO1, which is shown in FIG. 2 by a grayscale filled column.

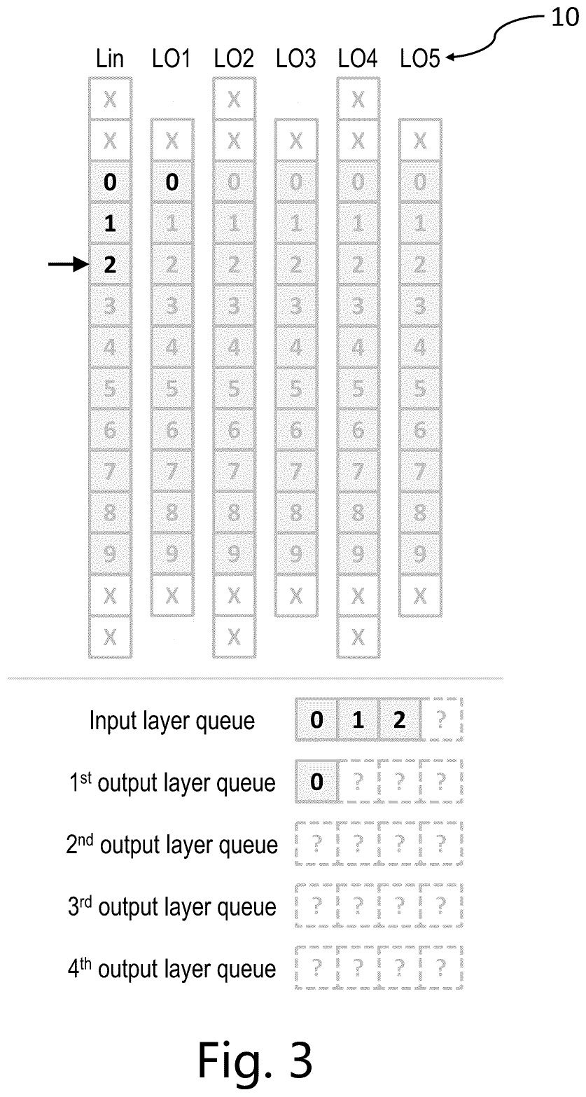

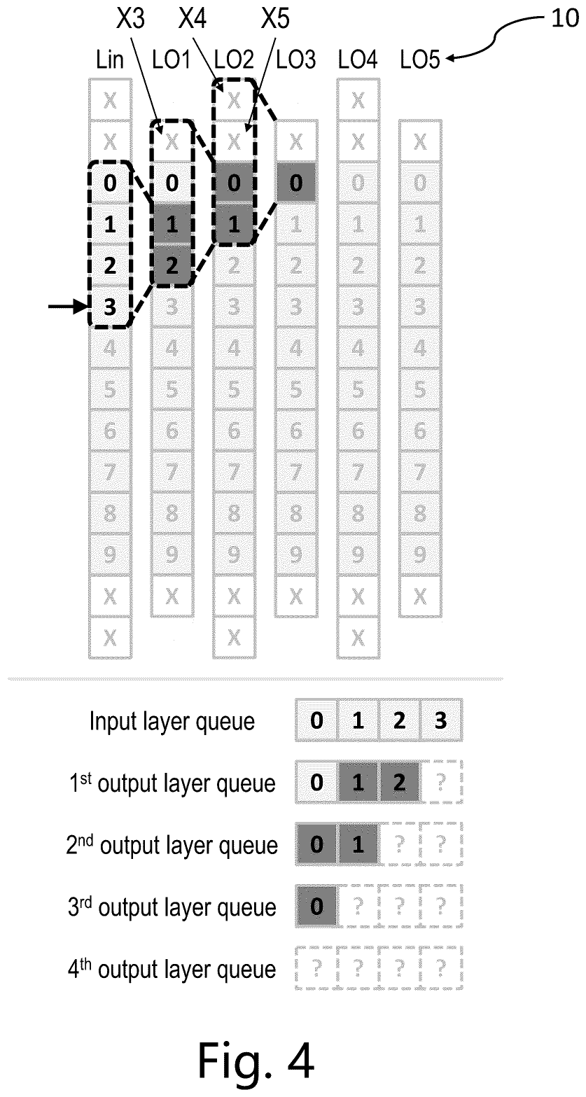

FIG. 3 shows a diagram schematically illustrating the image process consecutive convolution structure after FIG. 2, in which the third row line “2” of the input data is received and transmitted to the input layer Lin. And next, please refer to FIG. 4, which schematically shows a diagram illustrating the image process consecutive convolution structure after FIG. 3, in which the fourth row line “3” of the input data is received and transmitted to the input layer Lin. And therefore, according to the first row line “0”, the second row line “1”, the third row line “2” and the fourth row line “3” of the input data, the Winograd convolution between the input layer Lin and the first output layer LO1 can be performed so as to generate the first output layer queue. As can be seen in FIG. 4, at this point of time, the generated first output layer queue is the second line “1” and the third line “2” of the first output layer LO1, which are individually shown in FIG. 4 by a grayscale filled column.

As we can see, in order to perform the following Winograd convolution between the first output layer LO1 and the second output layer LO2, a third padding line X3 is provided to the first output layer LO1. According to the embodiment of the present invention, the third padding line X3 is adopted for providing zero-point data or providing an image data which is identical to the first line of the first output layer queue, i.e. the first row line “0” of the first output layer LO1.

As a result, according to the third padding line X3, the first row line “0”, the second row line “1” and the third row line “2” of the first output layer queue in the first output layer LO1, the Winograd convolution between the first output layer LO1 and the second output layer LO2 can be performed so as to generate the second output layer queue. As can be seen in FIG. 4, at this point of time, the generated second output layer queue is the first line “0” and the second line “1” of the second output layer LO2, which are individually shown in FIG. 4 by a grayscale filled column.

By applying the same manners, in order to perform the following Winograd convolution between the second output layer LO2 and the third output layer LO3, a fourth padding line X4 and a fifth padding line X5 are provided to the second output layer LO2. According to the embodiment of the present invention, the fourth padding line X4 and the fifth padding line X5 can be adopted for providing zero-point data, or the fourth padding line X4 and the fifth padding line X5 can be alternatively adopted for providing an image data which is identical to the first line of the second output layer queue, i.e. the first row line “0” of the second output layer LO2.

And therefore, it is believed that, according to the fourth padding line X4 and the fifth padding line X5, as well as the generated first row line “0” and the second row line “1” of the second output layer queue in the second output layer LO2, the Winograd convolution between the second output layer LO2 and the third output layer LO3 can be performed so as to generate the third output layer queue. As can be seen in FIG. 4, at this point of time, the generated third output layer queue is the first line “0” of the third output layer LO3, which is shown in FIG. 4 by a grayscale filled column.

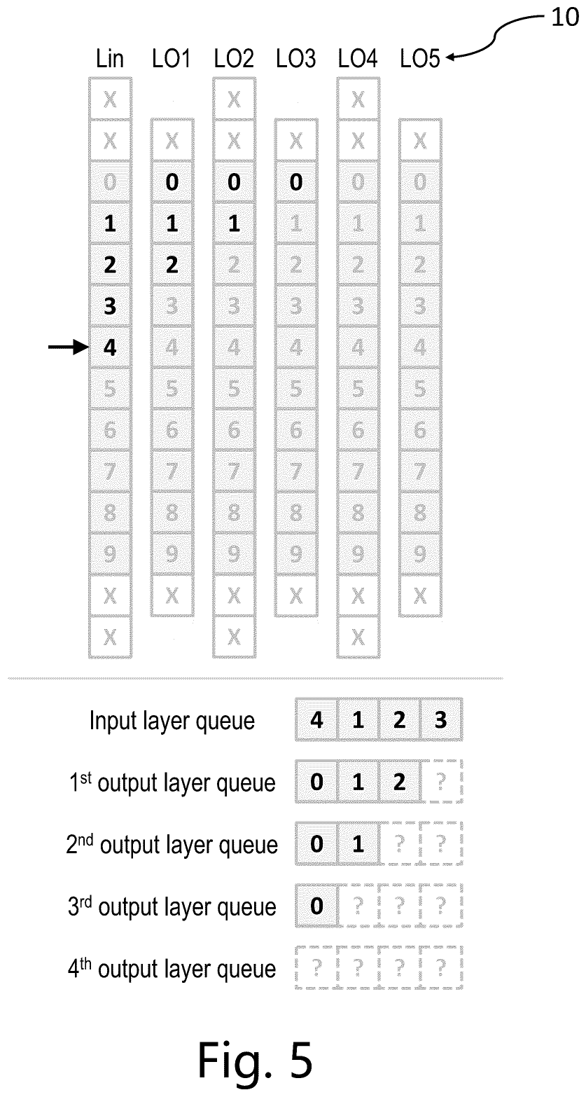

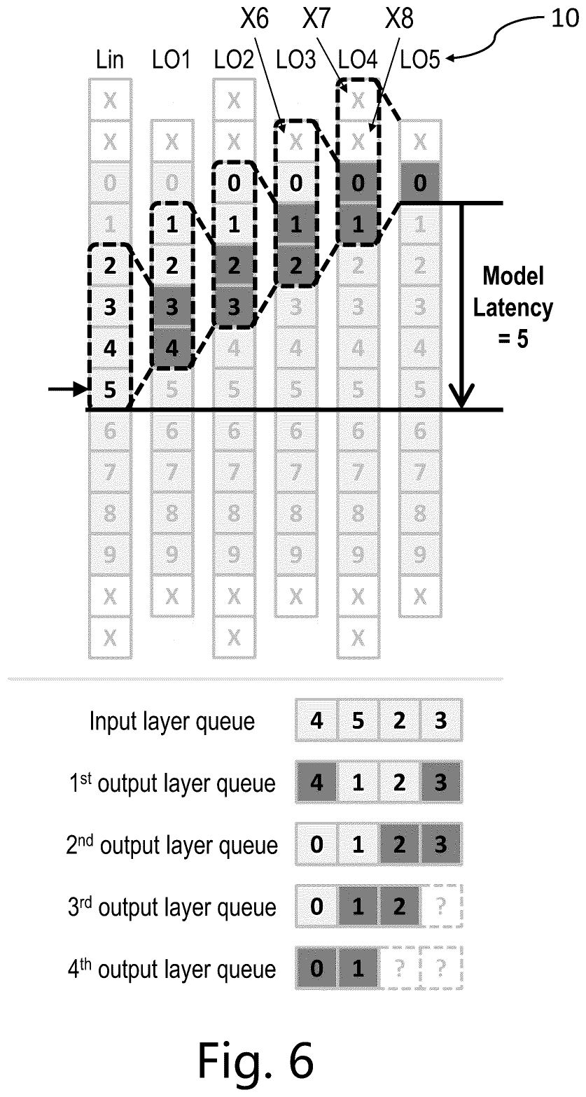

Later on, please refer to FIG. 5, which shows a diagram schematically illustrating the image process consecutive convolution structure after FIG. 4, in which the fifth row line “4” of the input data is received and transmitted to the input layer Lin. And next, please refer to FIG. 6, which schematically shows a diagram illustrating the image process consecutive convolution structure after FIG. 5, in which the sixth row line “5” of the input data is received and transmitted to the input layer Lin. And as such, upon receiving the third row line “2”, the fourth row line “3”, the fifth row line “4” and the sixth row line “5” of the input data, the Winograd convolution between the input layer Lin and the first output layer LO1 can be performed so as to generate the first output layer queue. As can be seen in FIG. 6, at this point of time, the generated first output layer queue is the fourth line “3” and the fifth line “4” of the first output layer LO1. And sequentially, according to the second row line “1”, the third row line “2”, the fourth row line “3” and the fifth row line “4” of the first output layer queue in the first output layer LO1, the Winograd convolution between the first output layer LO1 and the second output layer LO2 can be performed so as to generate the second output layer queue. As can be seen in FIG. 6, at this point of time, the generated second output layer queue is the third line “2” and the fourth line “3” of the second output layer LO2. By applying the same manners, according to the first row line “0”, the second row line “1”, the third row line “2” and the fourth row line “3” of the second output layer queue in the second output layer LO2, the Winograd convolution between the second output layer LO2 and the third output layer LO3 can be performed so as to generate the third output layer queue. As can be seen in FIG. 6, at this point of time, the generated third output layer queue is the second line “1” and the third line “2” of the third output layer LO3, which are individually shown in FIG. 6 by a grayscale filled column.

As can be seen in the drawing, in order to perform the following Winograd convolution between the third output layer LO3 and the fourth output layer LO4, a sixth padding line X6 is provided to the third output layer LO3. According to the embodiment of the present invention, the sixth padding line X6 is adopted for providing zero-point data. Alternatively, the sixth padding line X6 may also be adopted for providing an image data which is identical to the first line of the third output layer queue, which is the first row line “0” of the third output layer LO3.

As a result, according to the sixth padding line X6, the first row line “0”, the second row line “1” and the third row line “2” of the third output layer LO3, the Winograd convolution between the third output layer LO3 and the fourth output layer LO4 can be performed so as to generate the fourth output layer queue. As can be seen in FIG. 6, at this point of time, the generated fourth output layer queue is the first line “0” and the second line “1” of the fourth output layer LO4.

By applying the same manners, in order to perform the following Winograd convolution between the fourth output layer LO4 and the fifth output layer LO5, a seventh padding line X7 and an eighth padding line X8 are provided to the fourth output layer LO4. According to the embodiment of the present invention, the seventh padding line X7 and the eighth padding line X8 are adopted for providing zero-point data. According to other practicable embodiment of the present invention, then the seventh padding line X7 and the eighth padding line X8 may alternatively be adopted for providing an image data which is identical to the first line of the fourth output layer queue, which is the first row line “0” of the fourth output layer LO4.

And therefore, it is believed that, according to the seventh padding line X7 and the eighth padding line X8, as well as the generated first row line “0” and the second row line “1” of the fourth output layer LO4, the Winograd convolution between the fourth output layer LO4 and the fifth output layer LO5 can be performed so as to generate the fifth output layer queue. As can be seen in FIG. 6, at this point of time, the generated fifth output layer queue is the first line “0” of the fifth output layer LO5. By applying the disclosed process flow as mentioned above in the present invention, it is obviously verified that a model latency of 5, can be successfully obtained by performing the disclosed control method of the consecutive convolution structure of the proposed invention.

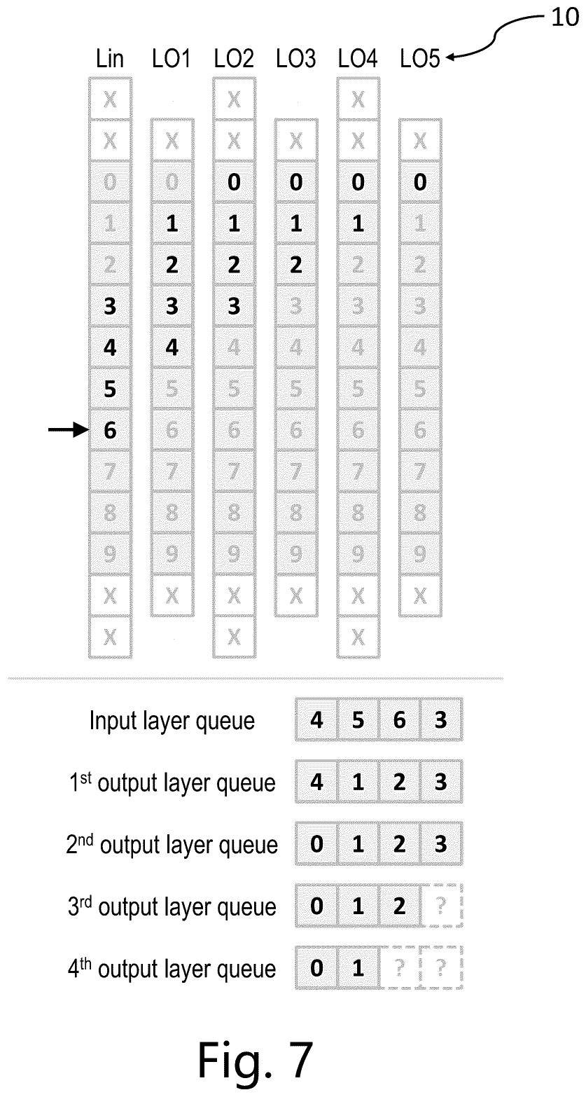

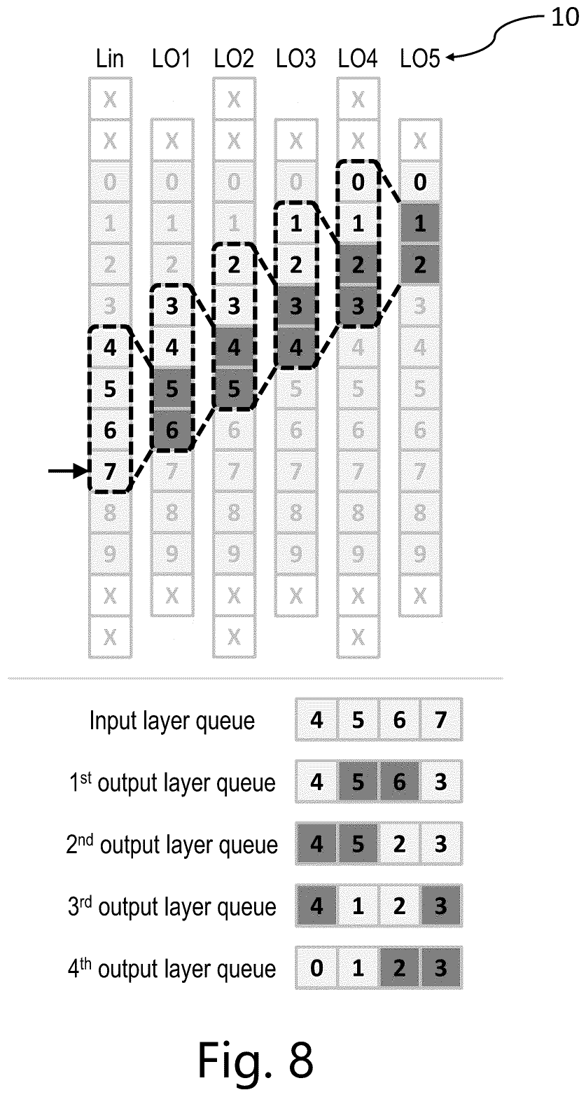

Later on, FIG. 7 shows a diagram schematically illustrating the image process consecutive convolution structure after FIG. 6, in which the seventh row line “6” of the input data is received and transmitted to the input layer Lin. And FIG. 8 schematically shows a diagram illustrating the image process consecutive convolution structure after FIG. 7, in which the eighth row line “7” of the input data is received and transmitted to the input layer Lin. As a result, based on the fifth row line “4”, the sixth row line “5”, the seventh row line “6” and the eighth row line “7” of the input data, the Winograd convolution between the input layer Lin and the first output layer LO1 can be performed so as to generate the sixth row line “5” and the seventh row line “6” of the first output layer queue. And subsequently, by applying the same methodologies, the Winograd convolution between the first output layer LO1 and the second output layer LO2, between the second output layer LO2 and the third output layer LO3, between the third output layer LO3 and the fourth output layer LO4, and between the fourth output layer LO4 and the fifth output layer LO5 are sequentially applied in order, such that the second output layer queue, the third output layer queue, the fourth output layer queue and the fifth output layer queue are accordingly generated. As referring to the figure as shown in FIG. 8, the generated row line in each of the output layer queue will be illustrated in a grayscale filled column for better recognition, which includes the sixth row line “5” and the seventh row line “6” of the first output layer LO1, the fifth row line “4” and the sixth row line “5” of the second output layer LO2, the fourth row line “3” and the fifth row line “4” of the third output layer LO3, the third row line “2” and the fourth row line “3” of the fourth output layer LO4 and the second row line “1” and the third row line “2” of the fifth output layer LO5.

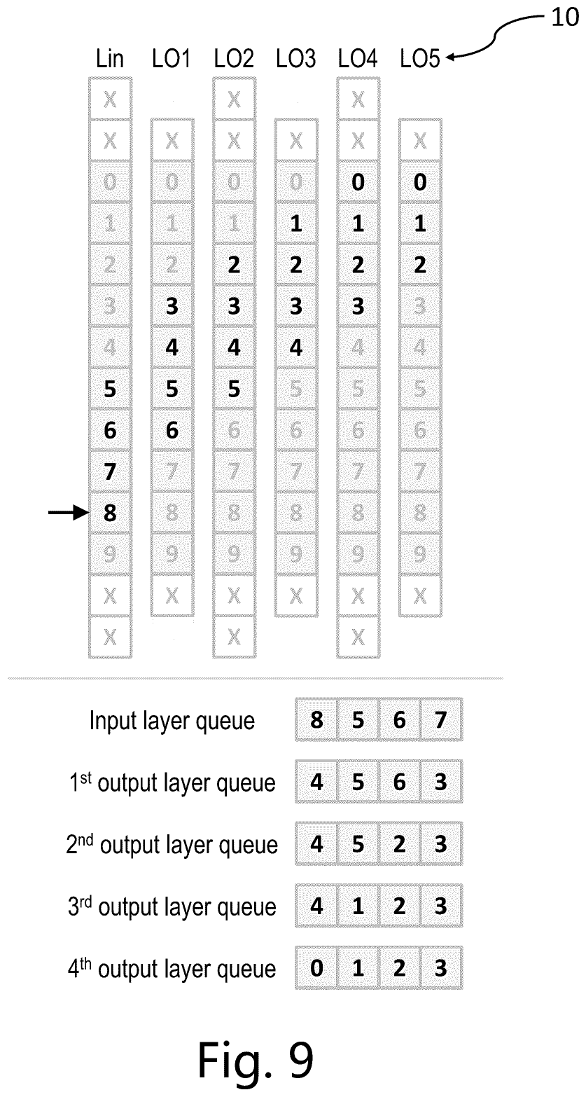

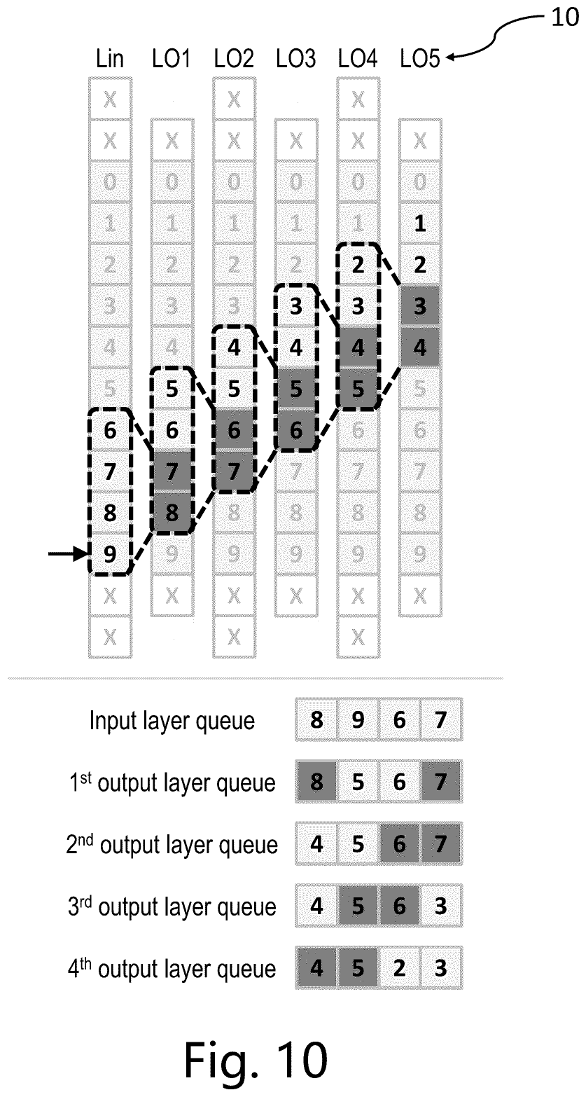

And then, FIG. 9 shows a diagram schematically illustrating the image process consecutive convolution structure after FIG. 8, in which the ninth row line “8” of the input data is received and transmitted to the input layer Lin. And FIG. 10 schematically shows a diagram illustrating the image process consecutive convolution structure after FIG. 9, in which the tenth row line “9” of the input data is received and transmitted to the input layer Lin. As a result, according to the seventh row line “6”, the eighth row line “7”, the ninth row line “8” and the tenth row line “9” of the input data, the Winograd convolution between the input layer Lin and the first output layer LO1 can be performed so as to generate the eighth row line “7” and the ninth row line “8” of the first output layer LO1. And subsequently, by applying the same methodologies, the Winograd convolution between the first output layer LO1 and the second output layer LO2, between the second output layer LO2 and the third output layer LO3, between the third output layer LO3 and the fourth output layer LO4, and between the fourth output layer LO4 and the fifth output layer LO5 are sequentially applied in order, such that the second output layer queue, the third output layer queue, the fourth output layer queue and the fifth output layer queue are accordingly generated. As referring to the figure as shown in FIG. 10, the generated row lines in each of the output layer queue are also illustrated in a grayscale filled column for distinguishable recognition, which includes the eighth row line “7” and the ninth row line “8” of the first output layer LO1, the seventh row line “6” and the eighth row line “7” of the second output layer LO2, the sixth row line “5” and the seventh row line “6” of the third output layer LO3, the fifth row line “4” and the sixth row line “5” of the fourth output layer LO4 and the fourth row line “3” and the fifth row line “4” of the fifth output layer LO5.

As a result, to sum up, it is significantly obtained that the present invention discloses a control method of a consecutive convolution structure, which is proposed to integrate the Winograd convolution with a line interleaved process so as to enhance the algorithm efficiency. The disclosed improved convolutional algorithm of the present invention is based on a depth-first processing flow and is involved with integrating the line interleaved computing methods. Therefore, it is believed that a minimum latency of the convolutional neural network model is effectively achieved. In addition, in view of the disclosed process flow as provided in FIG. 1 to FIG. 10, it is obvious that, in each data layer, it requires only a four-line buffer at one time to complete the image data transformation operation, thereby a conventional SRAM size is found to be significantly saved.

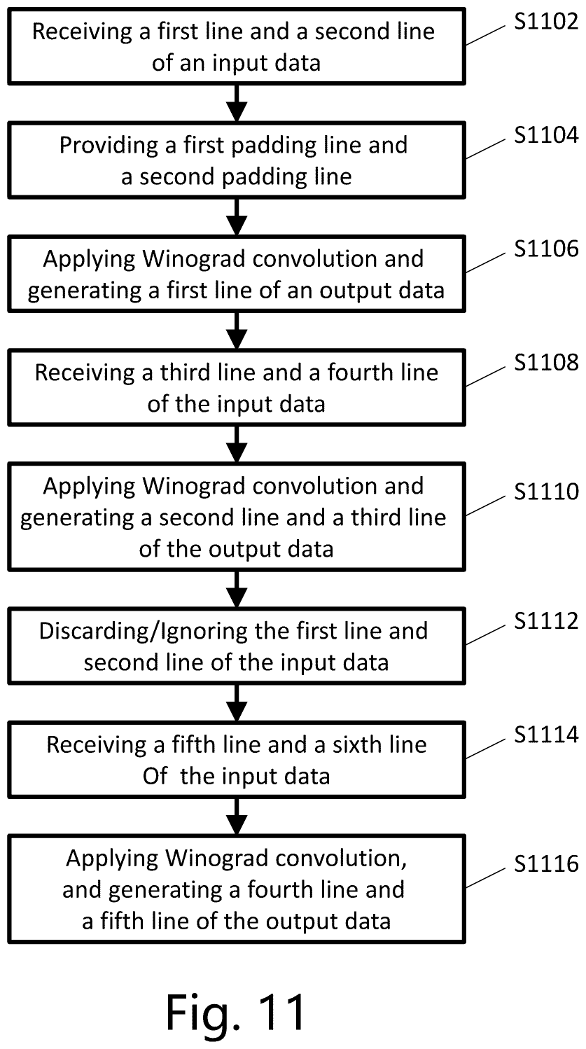

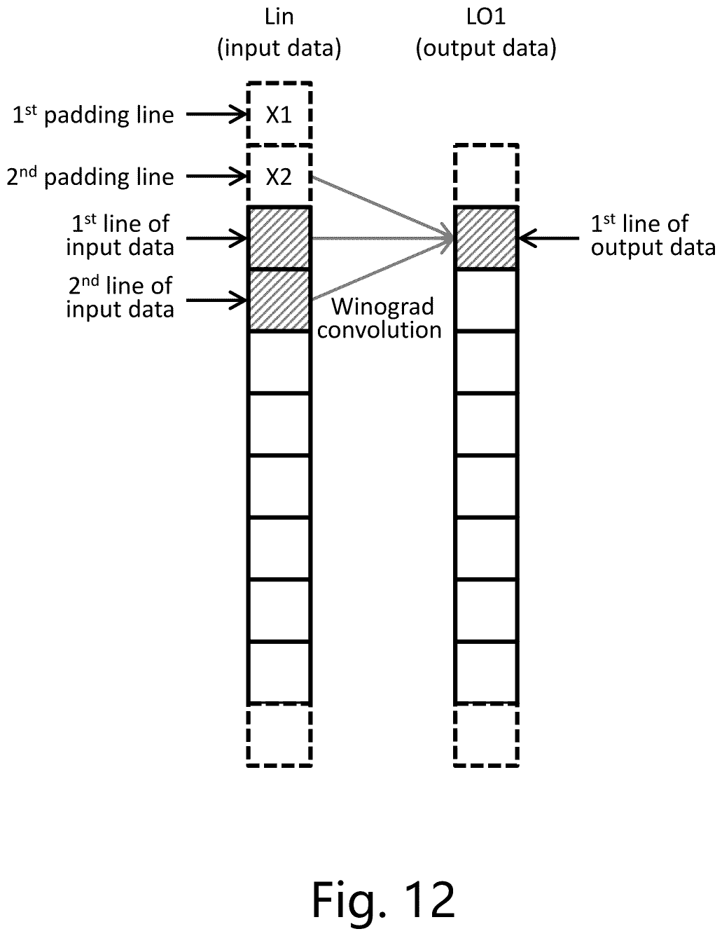

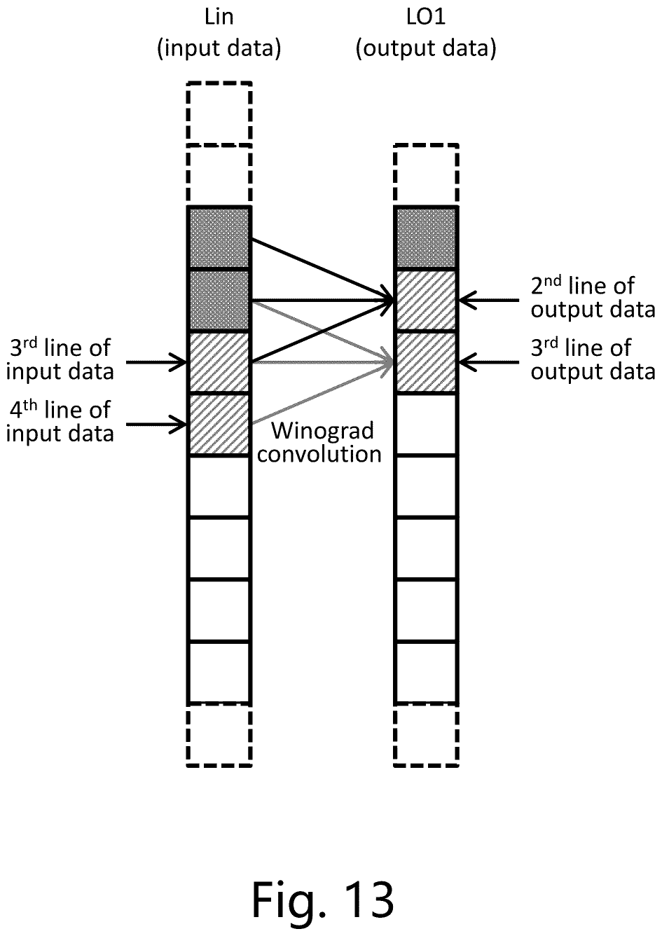

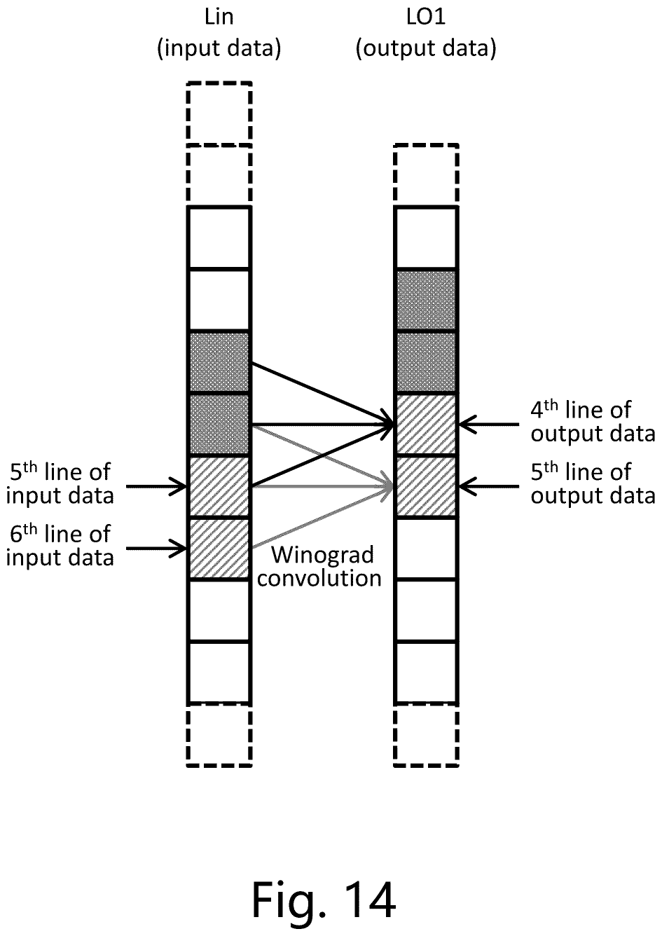

Moreover, according to the disclosed process flow as provided in FIG. 1 to FIG. 10, it can be concluded and summarized that for obtaining the generated output layer queue in the odd output layers, for instance, the first output layer LO1, the third output layer LO3, the fifth output layer LO5, and so on, the provided control method of the consecutive convolution structure includes a plurality of following steps, which are as provided in FIG. 11 of the present invention, comprising the steps of S1102, S1104, S1106, S1108, S1110, S1112, S1114 and S1116. In the following paragraphs, for clarifying and describing the process flows of the disclosed control method regarding obtaining the generated output layer queue in the odd output layers, the Applicants of the present invention simply take the input layer Lin and the first output layer LO1, and the Winograd convolution performed in between the input layer Lin and the first output layer LO1 as an exoplanar embodiment for reference. Please also refer to FIG. 12, FIG. 13 and FIG. 14 at the same time, wherein each of the figures respectively shows corresponding diagrams in related to the performing steps in FIG. 11.

For illustrating a first operation period, please refer to the steps S1102, S1104, S1106 in FIG. 11 and FIG. 12 at the same time. As shown in the step of S1102, a first line and a second line of an input data is received. And then, in the step of S1104, a first padding line X1 and a second padding line X2 are provided. As described earlier in the present invention, the first padding line X1 and/or the second padding line X2 is able to alternatively provide zero-point data or an image data which is identical to the first line of the input data. As such, in the step of S1106, the Winograd convolution can be applied so as to generate the first line of an output data.

Later, a second operation period is carried out, as indicated by the steps of S1108 and S1110 in FIG. 11. For the second operation period, please refer to FIG. 13 at the same time. As can be seen in FIG. 13, a third line and a fourth line of the input data is received (corresponding to the step of S1108). And as a result, in the step of S1110, the Winograd convolution can be applied so as to generate the second line and the third line of the output data.

And successively, a third operation period will be performed, as indicated by the steps of S1112, S1114 and S1116 in FIG. 11. For the third operation period, please refer to FIG. 14 at the same time. As we can see, in the step of S1112, the foregoing first line and second line of the input data are discarded. And in the step of S1114, a fifth line and a sixth line of the input data can be received such that, in the step of S1116, the Winograd convolution can be applied so as to generate the fourth line and the fifth line of the output data.

According to the embodiment of the present invention, when performing the steps of S1102, S1108 and S1114 while the input data is received, it is applicable that the first line, the second line, the third line, the fourth line, the fifth line and the sixth line of the input data can be temporarily stored in a buffer for the sequential processing flow. And since it requires only a four-line buffer in each data layer at one time in order to temporarily store the input data, a conventional SRAM size can be significantly reduced by employing the disclosed technical contents of the present invention.

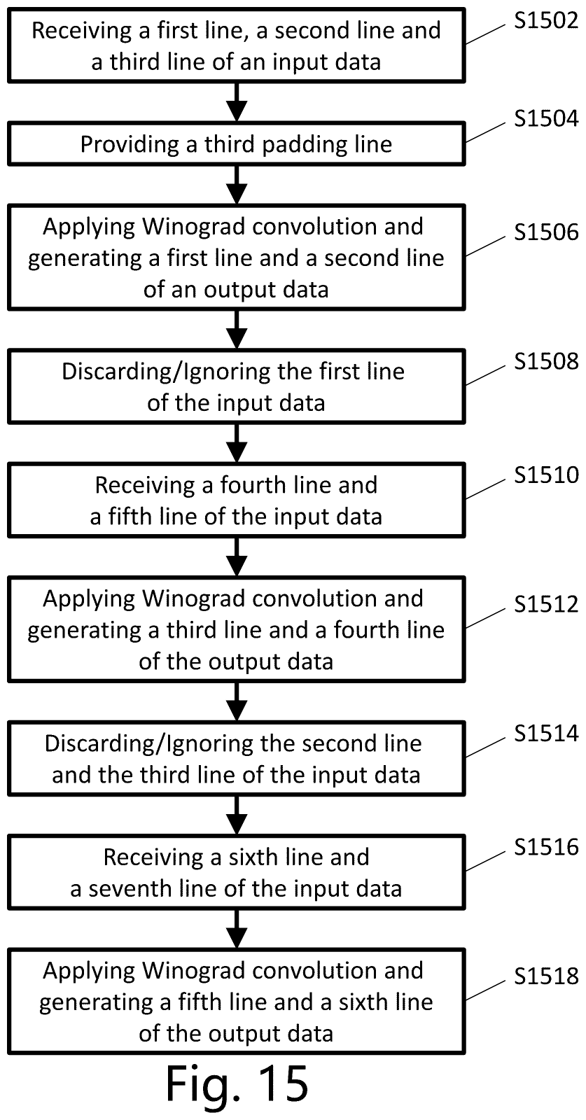

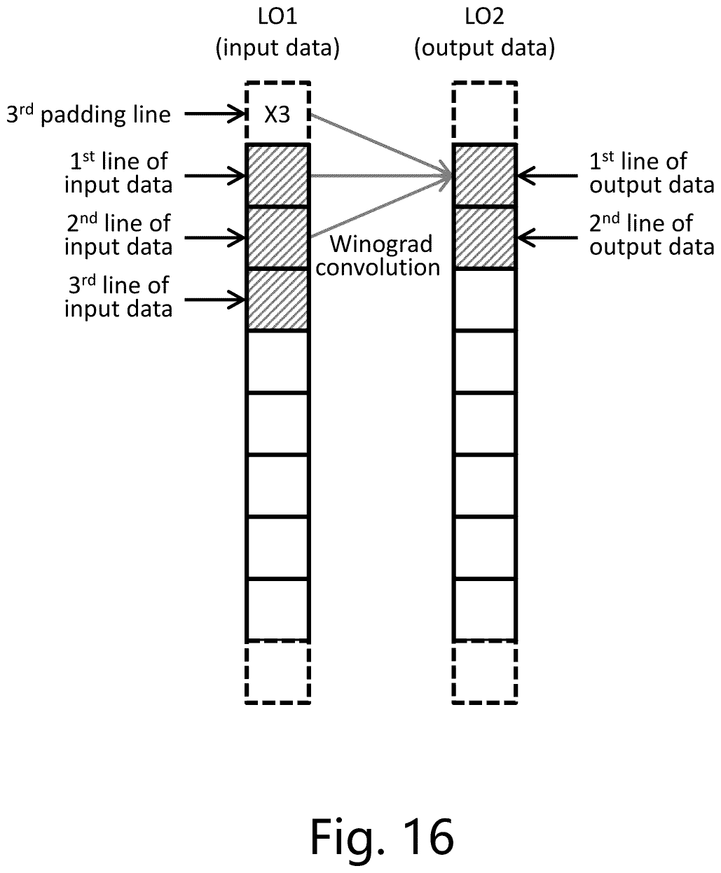

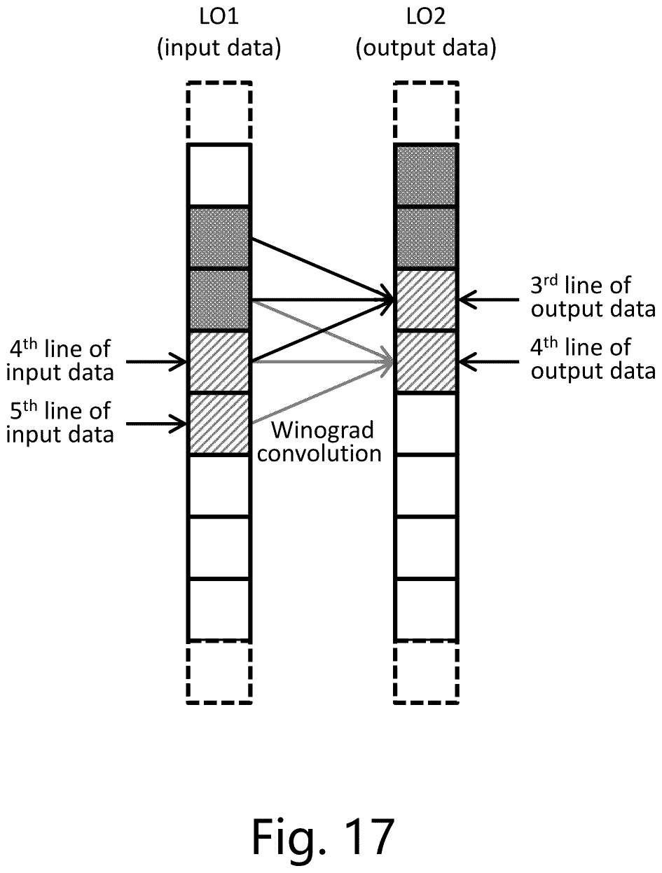

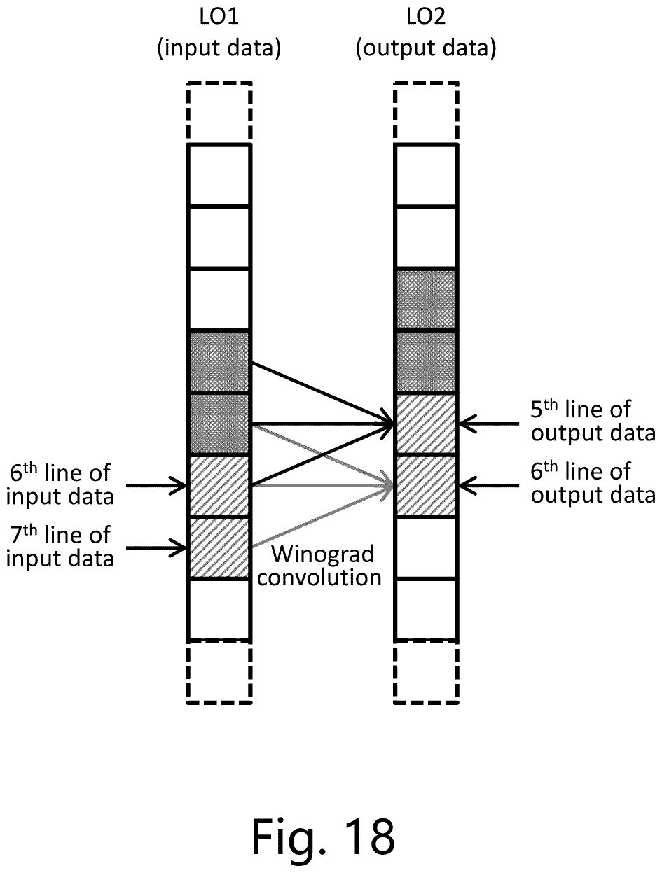

In addition to the above disclosed method, the present invention, in another aspect also proposes a control method of the consecutive convolution structure for obtaining the generated output layer queue in the even output layers, for instance, the second output layer LO2, the fourth output layer LO4, the sixth output layer LO6, and so on. In the following sections, in order to provide a detailed and comprehensive description explaining the process flows of the disclosed control method regarding obtaining the generated output layer queue in the even output layers, the Applicants of the present invention simply take the first output layer LO1 and the second output layer LO2, for instance, and the Winograd convolution performed in between the first output layer LO1 and the second output layer LO2 as an exoplanar embodiment for reference. FIG. 15 shows a process flow of the disclosed control method of the consecutive convolution structure for obtaining the output layer queue in the even output layers according to an alternative embodiment of the present invention. And the proposed control method of the consecutive convolution structure for obtaining the output layer queue in the even output layer includes the steps of S1502, S1504, S1506, S1508, S1510, S1512, S1514, S1516 and S1518. FIG. 16, FIG. 17 and FIG. 18 respectively shows corresponding diagrams in related to the performing steps in FIG. 15. Please refer to these diagrams at the same time for a better understanding of the technical content of the present invention.

As we can see in FIG. 16, FIG. 17 and FIG. 18, regarding obtaining the output layer queue in the even output layer (hereinafter, the second output layer LO2), it is defined that the first output layer LO1 is adopted for providing an input data, while the second output layer LO2 is adopted for generating the output data.

In a first operation period of the disclosed control method, please refer to the steps S1502, S1504 and S1506 in FIG. 15 as well as FIG. 16 at the same time. As indicated in the step of S1502, a first line, a second line and a third line of an input data are received. And then, in the step of S1504, a third padding line X3 is provided as shown in FIG. 16. As described earlier in the present invention, the third padding line X3 is employed for alternatively providing a zero-point data or an image data which is identical to the first line of the input data. As such, in the step of S1506, the Winograd convolution between the first output layer LO1 and the second output layer LO2 can be applied so as to generate the first line and the second line of an output data.

And next, for a second operation period of the disclosed control method, please refer to FIG. 17 along with the steps of S1508, S1510 and S1512 in FIG. 15 at the same time. Before performing the step of S1510 receiving a fourth line and a fifth line of the input data, the foregoing first line of the input data is discarded and ignored in the step of S1508. And as such, it is operable to receive the fourth line and the fifth line of the input data in the step of S1510. And as a result, in the step of S1512, the Winograd convolution between the first output layer LO1 and the second output layer LO2 can be applied so as to generate the third line and the fourth line of the output data.

And successively, a third operation period will be performed, as indicated by the steps of S1514, S1516 and S1518 in FIG. 15. For the third operation period, please refer to FIG. 18 at the same time. As we can see, before performing the step of S1516 to receive a sixth line and a seventh line of the input data, the foregoing second line and the third line of the input data are discarded and ignored in the step of S1514. And as such, it is operable to receive the sixth line and the seventh line of the input data in the step of S1516. And as a result, in the step of S1518, the Winograd convolution between the first output layer LO1 and the second output layer LO2 can be applied so as to generate the fifth line and the sixth line of the output data.

In addition, according to such an alternative embodiment of the present invention, when performing the steps of S1502, S1510 and S1516 while the input data is received, it is applicable that the first line, the second line, the third line, the fourth line, the fifth line, the sixth line and the seventh line of the input data can be temporarily stored in a buffer for the sequential processing flow. And apparently, since it also requires only a four-line buffer in each data layer at one time to temporarily store the input data, a conventional SRAM size is believed to be significantly reduced by employing the disclosed technical contents of the present invention.

Furthermore, as provided in the following, the Applicants of the present invention additionally provide a plurality of data so as to verify and prove that the disclosed technical contents of the present invention are effective. Please refer to Table 1 as below, which compares the present invention with the conventional arts while each of the conventional arts and the proposed invention is respectively applied to a convolutional neural network structure.

TABLE 1

| | Conventional arts | The proposed invention |
|---|---|---|
| Area (MAC) | x1 | x0.44 |
| Area (SRAM-fmap) | x1 | x1.33 |
| Area (SRAM-skip) | x1 | x1 |
| Model Latency | x1 | x1 |

From the above comparison Table 1, since the proposed invention replaces the conventional 3*3 convolution with the F(2*2,3*3) Winograd convolution, it can be found that 56% of the array area of multiply-accumulate (MAC) circuits can be effectively saved when adopting the proposed invention. Moreover, the model latency of the convolutional neural network structure can be maintained approximately the same without being increased while employing the proposed invention. And as a result, it is believed that an optimal and improved convolutional algorithm integrating with line interleaved computing methods as disclosed in the present invention has been proposed and provided by the Applicants of the present invention.

According to the present invention, the foregoing disclosed control method of a consecutive convolution structure is illustrated as being applied to a kernel size of 3*3 convolution structures, for example. And yet the invention is not limited to such 3*3 convolution structure. Alternative preferable kernel-sized of (n*n) convolution structures are also compatible.

Therefore, based on at least one embodiment provided above, it is believed that the proposed control method of a consecutive convolution structure of the present invention is characterized by integrating the Winograd convolution with a line interleaved process. By employing the proposed control method, the present invention is believed as beneficial to reducing the array area of multiply accumulate circuits and power consumption thereof. As a result, when compared to the prior arts, it is obvious that the present invention apparently shows much more effective performances than before. In addition, it is believed that the present invention is instinct, effective and highly competitive for IC technology and industries in the market nowadays, effectively reducing the array area of multiply accumulate circuits and power consumption, whereby having extraordinary availability and competitiveness for future industrial developments and being in condition for early allowance.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A control method of a consecutive convolution structure, comprising a plurality of steps of:
in a first operation period, receiving a first line and a second line of an input data, applying Winograd convolution and generating a first line of an output data;
in a second operation period, receiving a third line and a fourth line of the input data, applying Winograd convolution and generating a second line and a third line of the output data; and
in a third operation period, receiving a fifth line and a sixth line of the input data, applying Winograd convolution and generating a fourth line and a fifth line of the output data.

2. The control method of the consecutive convolution structure according to claim 1, in the step of receiving the first line and the second line of the input data and applying Winograd convolution further comprising providing a first padding line and a second padding line for generating the first line of the output data.

3. The control method of the consecutive convolution structure according to claim 2, wherein either the first padding line or the second padding line is alternatively providing zero-point data or an image data which is identical to the first line of the input data.

4. The control method of the consecutive convolution structure according to claim 1, before the step of receiving the fifth line and the sixth line of the input data, further comprising discarding the first line and the second line of the input data.

5. The control method of the consecutive convolution structure according to claim 1, wherein the first line, the second line, the third line, the fourth line, the fifth line and the sixth line of the input data is temporarily stored in a buffer.

6. A control method of a consecutive convolution structure, comprising a plurality of steps of:
in a first operation period, receiving a first line, a second line and a third line of an input data, applying Winograd convolution and generating a first line and a second line of an output data;
in a second operation period, receiving a fourth line and a fifth line of the input data, applying Winograd convolution and generating a third line and a fourth line of the output data; and
in a third operation period, receiving a sixth line and a seventh line of the input data, applying Winograd convolution and generating a fifth line and a sixth line of the output data.

7. The control method of the consecutive convolution structure according to claim 6, in the step of receiving the first line, the second line and the third line of the input data and applying Winograd convolution further comprising providing a third padding line for generating the first line and the second line of the output data.

8. The control method of the consecutive convolution structure according to claim 7, wherein the third padding line is alternatively providing zero-point data or an image data which is identical to the first line of the input data.

9. The control method of the consecutive convolution structure according to claim 6, before the step of receiving the fourth line and the fifth line of the input data, further comprising discarding the first line of the input data.

10. The control method of the consecutive convolution structure according to claim 6, before the step of receiving the sixth line and the seventh line of the input data, further comprising discarding the second line and the third line of the input data.

11. The control method of the consecutive convolution structure according to claim 6, wherein the first line, the second line, the third line, the fourth line, the fifth line, the sixth line and the seventh line of the input data is temporarily stored in a buffer.
